(19) United States
(12) Patent Application Publication
(10) Pub. No.: US 2012/0193428 A1
(43) Pub. Date: Aug. 2, 2012

(54) Optical Information Reading Device

(75) Inventor: Yinggang Bu, Saitama (JP)

(73) Assignee: OPTOELECTRONICS CO., LTD., Warabi-shi (JP)

(21) Appl. No.: 13/432,460

(22) Filed: Mar. 28, 2012

Related U.S. Application Data
(63) Continuation of application No. PCT/JP2010/066993, filed on Sep. 29, 2010.

(30) Foreign Application Priority Data
Sep. 29, 2009 (JP) 2009-224805

(51) Int. Cl. G06K 7/14

(52) U.S. Cl. 235/462.36

(57) ABSTRACT

An optical-information-reading apparatus has a light-irradiating portion which emits light, a movable member which includes a scanning mirror reflecting light emitted from the light-irradiating portion, and a supporting member 4 which supports the movable member rotatably. A coil 5 drives the movable member rotatably, and a light-receiving portion which receives reflected light and is scanned across a code symbol by the rotation of the movable member 3. The supporting member contains a plate spring opposite ends of which are fixed on the movable member, and a fixed axle supports a middle of the plate spring.

### BACKGROUND OF THE INVENTION

The present invention relates to an optical-information-reading apparatus which reads information from a signal obtained by performing optical scanning on an object to be read composed of patterns having different optical reflectivity such as a one-dimensional code and a two-dimensional code and receiving reflected light by the object to be read to perform photoelectric conversion thereon.

As an optical-information-reading apparatus, a barcode reader that reads bar code, which is one-dimensional code, indicating any information about name and price of goods has been widely used in the distribution industry and retail industry. Such a barcode readers are classified roughly into a hand-held type and a stationary type and in the hand-held barcode reader, downsizing thereof, low driving voltage and high durability are required.

The barcode reader, which is known as a light beam scanner, among the barcode readers of the hand-held type, beams laser light emitted from a light source such as laser diode, deflects the light beam by rotating or vibrating a mirror reflecting this light beam, and scans it across the bar code. The reflected light from the bar code is then focused and received by a light-receiving sensor to be converted to an electric signal. A/D conversion is performed on the electric signal thus obtained to be encoded, which is output as the barcode-reading information.

Thus, as a light-scanning mechanism for rotating or vibrating the mirror, a configuration such that a shaft is a rotating shaft of a mirror has been proposed (for example, see Patent Document 1 below).

Further, a confirmation has been proposed such that an end of a plate spring is fixed and a mirror is attached to the other end thereof, the mirror being supported by the plate spring. For example, see Patent Document 2 below). Further, a configuration such that both ends of plate spring are fixed on a base and a rotatable mirror is fixed on a middle thereof via a jig has been proposed (for example, see Patent Document 3 below).

### Patent Documents

Patent Document 1: WO 03/019463

Patent Document 2: Japanese Patent No. 3199767

Patent Document 3: Japanese Patent Application Publication No. H05-266236

### SUMMARY OF THE INVENTION

In a configuration embodied such that the shaft as the rotating shaft supports the mirror, abrasion occurs in a bearing supporting the shaft so that long term durability is deteriorated. Clatters are generated during the rotation operation because of space between the shaft and the bearing.

In a configuration embodied such that the mirror is supported by the plate spring at one end thereof, a rotation center of the mirror is away from a middle of the mirror through which an optical axis passes, so that optical properties thereof are deteriorated. In the configuration supporting both ends of plate spring, an axis which is the rotation axis of the mirror is displaced laterally by any deformation of the plate spring so that it is difficult to get a stable vibration.

The present invention solves such problems and has an object to provide an optical-information-reading apparatus which allows the mirror to be stably rotated and can realize long-life thereof.

In order to solve the above-mentioned problem, an embodiment in accordance with the present invention offers an optical-information-reading apparatus that is provided with a light-irradiating portion which emits light, a movable member which includes a mirror reflecting the light emitted from the light-irradiating portion, a supporting portion which supports the movable member rotatably, a driving portion which drives the movable member rotatably, and a light-receiving portion which receives reflected light emitted from the light-irradiating portion which is scanned across an object to be read by the rotation of the movable member, wherein the supporting portion contains a plate elastic member having opposite ends fixed on the movable member, and a fixed axle which supports a middle of the elastic member.

In an optical-information-reading apparatus embodying the invention, the light emitted from the light-irradiating portion and reflected by the mirror is deflected by rotating the movable member and is scanned across the object to be read, composed of patterns having different optical reflectivity. The reflected light of the light scanned across the object to be read is received by the light-receiving portion and any information therein is read from a signal on which photoelectric conversion is performed. In the movable member, the elastic member is elastically deformed around the fixed axle as a fulcrum, so that rotation of the mirror is performed.

In an optical-information-reading apparatus embodying the invention, as the middle of the elastic member, opposite ends of which are fixed on the movable member, is supported by the fixed axle, it is possible to restrain lateral movement or a distortion of the axis during rotation of the mirror, which enables the rotation thereof to be performed stably. Further, there is no rubbed portion accompanying the rotation thereof, which causes no deterioration by abrasion, so that it is possible to improve durability and realize long-life thereof. Additionally, no unusual sounds occur in the rubbed portion, which allows sounds of the rotation thereof to be damped.

### BRIEF DESCRIPTION OF THE DRAWINGS

FIG. 1 is a perspective view of an optical-information-reading apparatus according to a first embodiment;

FIG. 2 is a plan view of the optical-information-reading apparatus according to the first embodiment;

FIG. 3 is a plan view of the optical-information-reading apparatus according to the first embodiment showing a variation example thereof;

FIG. 4 is a plan view of the optical-information-reading apparatus according to the first embodiment showing a variation example thereof;

FIG. 5 is a plan view of the optical-information-reading apparatus according to the first embodiment showing a variation example thereof;

FIG. 6 is a plan view of an optical-information-reading apparatus according to a second embodiment;

FIG. 7 is a front view of a portion of an optical-information-reading apparatus according to a third embodiment;

FIG. 8 is a front view of a portion of an optical-information-reading apparatus according to the third embodiment;

FIG. 9 is a plan view of a portion of an optical-information-reading apparatus according to the third embodiment;

FIG. 10 is a plan view of a portion of an optical-information-reading apparatus according to the third embodiment;

FIG. 11 is a plan view of a portion of an optical-information-reading apparatus according to the third embodiment;

FIG. 12 is a graph showing characteristics of maximum stress amplitude and repetition cycling;

FIG. 13 is a plan view of the optical-information-reading apparatus according to each embodiment showing a specific configuration example thereof;

FIG. 14 is a perspective view of the optical-information-reading apparatus according to FIG. 13;

FIG. 15 is an exploded perspective view of the optical-information-reading apparatus according to FIG. 13;

FIG. 16 is an exploded perspective view of a scanning mirror assembly;

FIG. 17 is an explanatory drawing of the optical-information-reading apparatus according to this embodiment showing a first alignment operation example of the optical axis; and

FIG. 18 is an explanatory drawing of the optical-information-reading apparatus according to this embodiment showing a second alignment operation example of the optical axis.

### DETAILED DESCRIPTION

The following will describe embodiments of an optical-information-reading apparatus according to the present invention with reference to the drawings.

### Configuration Example of Optical-Information-Reading Apparatus According to First Embodiment

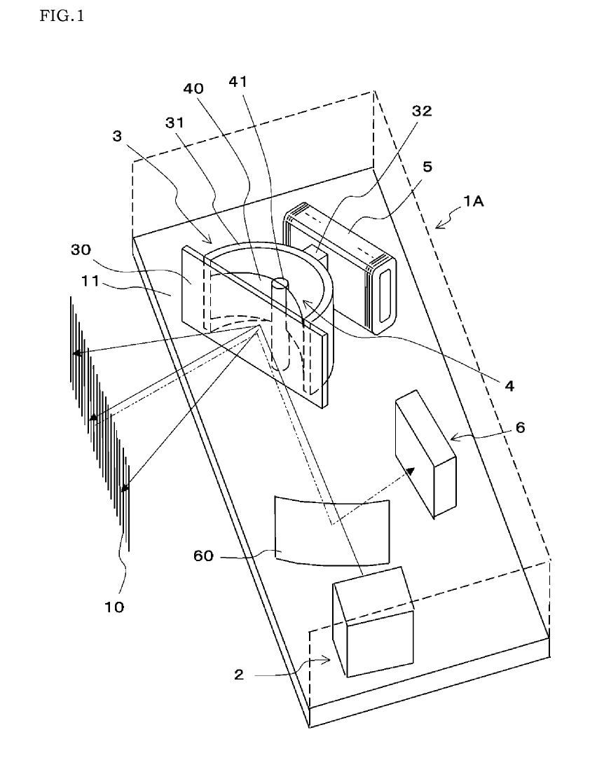

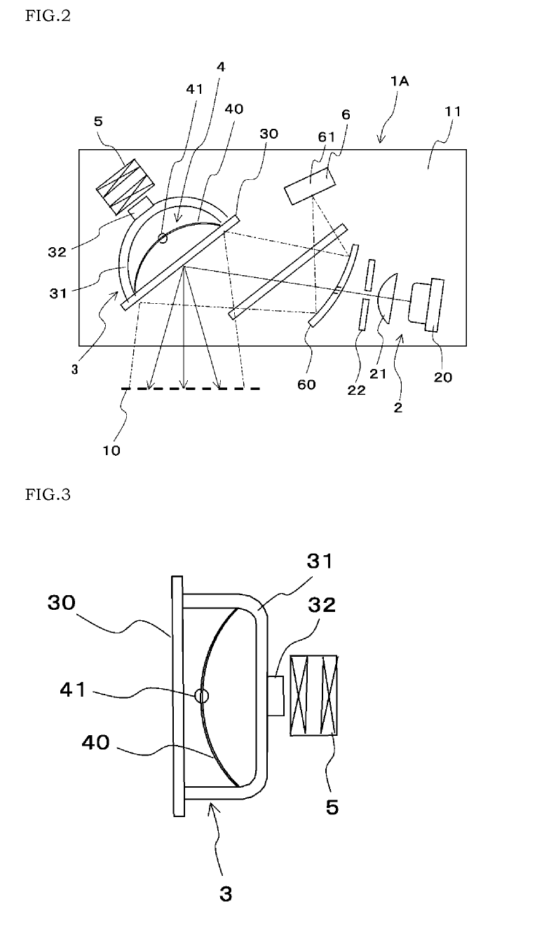

FIG. 1 is a perspective view of an optical-information-reading apparatus according to a first embodiment showing an example thereof. FIG. 2 is a plan view of the optical-information-reading apparatus according to the first embodiment showing the example thereof.

In the optical-information-reading apparatus 1A according to the first embodiment, the movable member 3 has a scanning mirror 30 that reflects light emitted from the light-irradiating portion 2. Mirror 30 is supported by the supporting member 4 having a plate spring 40 as an elastic member, for example, plate.

In the optical-information-reading apparatus 1A, by driving a coil 5, the movable member 3 rotates with vibrations within a predetermined angle. The optical-information-reading apparatus 1A deflects the light emitted from the light-irradiating portion 2 and reflected by the scanning mirror 30 and, by rotating the scanning mirror 30, scans it across a code symbol 10 composed of patterns having different optical reflectivity. For example, code symbol 10 may be a one-dimensional code, which is known as a bar code, having information in a lateral direction thereof, or a two-dimensional code having information in vertical and lateral directions thereof.

Further, the optical-information-reading apparatus 1A receives the reflected light of the light scanned across the code symbol 10 via a light-receiving portion 6 and reads the information from the received light on which a photoelectric conversion is performed.

The light-irradiating portion 2 is provided with a light source 20 composed of a semiconductor laser (LD) or the like, a lens 21 focusing the light radiated from the light source 20 with a predetermined angle of radiation, and an aperture 22 that subdues the light focused by the lens 21, and emits beam light which is obtained by focusing the light radiated from the light source 20 or which is a parallel beam thereof.

Light that is scanned across the code symbol 10 is reflected by the scanning mirror 30 to a mirror 60 on light-receiving portion 6. Mirror 60 reflects the light from mirror 30 to a photodiode (PD) which receives the light and performs photoelectric conversion thereon to create an output signal.

The movable member 3 is provided with the above-mentioned scanning mirror 30, a frame 31 attached to a rear surface of the scanning mirror 30 and a permanent magnet 32 attached to the frame 31. The scanning mirror 30 is flat and its surface facing symbol 10 is formed as a reflected surface. The frame 31 is composed of, for example, a circular member with either end thereof fixed on the rear surface of the scanning mirror 30. An exterior circumference of the frame 31 is formed as a convex curved surface and, on an inner circumference of the frame 31, a space is formed between it and the rear surface of the scanning mirror 30. The permanent magnet 32 is attached to the outer circumference of the frame 31.

The supporting member 4 is provided with the above-mentioned plate spring 40 and a fixed axle 41 supporting the plate spring 40. The plate spring 40 constitutes an elastic member which is composed of a steel material, such as stainless steel, and it has a rectangular plate shape and is positioned in the space between the rear surface of the scanning mirror 30 and the inner circumference of the frame 31. The plate spring 40 is bent into a state in which the plate spring 40 is elastically deformed to have an arc shape that is convex in relation to the scanning mirror 30 by bending the opposite longitudinal ends thereof toward the same direction, and both longitudinal ends thereof are fixed on both ends of the frame 31 on a rear surface side of the scanning mirror 30.

The fixed axle 41 stands on a base member 11 on which its lower end is fixed, the light-irradiating portion 2, the coil 5, the light-receiving portion 6, and the like, also being mounted on base member 11. The plate spring 40 is configured so that an intermediate portion between the ends thereof (fixed on the movable member 3) is fixed on upper end of the fixed axle 41. The movable member 3 is configured so that the fixed axle 41 aligned with an upright center line in a lateral direction of the scanning mirror 30, and an optical axis of the light emitted from the light-irradiating portion 2 passes approximately through the center of the scanning mirror 30.

This enables the movable member 3 to keep the scanning mirror 30 stationary orientation in a state in which a stress is exerted on the plate spring 40. The plate spring 40 is elastically deformed around the fixed axle 41 as a fulcrum so that the movable member 3 enables the scanning mirror 30 to rotate. An axis which is a center of the rotation of the scanning mirror 30 is positioned on the center line of the scanning mirror 30 and slightly behind the fixed axle 41. Here, a rotation angle of the movable member 3, the shape of the plate spring 40 and the like are set so that when the movable member 3 rotates, the stress exerted on the plate spring 40 is not zero.

The coil 5 is mounted on the base member 11 so that it faces the permanent magnet 32 of the movable member 3 and the coil 5 and the permanent magnet 32 constitute the driving portion. When the coil 5 is driven and electric current flows therethrough, an impellent force occurs in a horizontal direction along the longitudinal direction of the plate spring 40 on the basis of an action of magnetic flux of the opposed permanent magnet 32. The impellent force on the permanent magnet 32 is transferred to the plate spring 40 through the frame 31. Accordingly, the plate spring 40 is elastically deformed and bent around the fixed axle 41 as a fulcrum so that the scanning mirror 30 rotates.

By changing a direction of the electric current flowing through the coil 5, the direction of the impellent force on the permanent magnet 32 is changed so that the scanning mirror 30 rotates with vibration within a predetermined angle based on the impellent force on the permanent magnet 32 and restoring force of the plate spring 40. It is to be noted that a yoke of iron core may is included in the coil 5, and by including the yoke thereinto, the impellent force may be increased.

### Example of Operation and Effect of Optical-Information-Reading Apparatus according to First Embodiment

Since the axis which is a center of the rotation of the scanning mirror 30 becomes an imaginary fulcrum when the plate spring 40 is deformed, there is no rubbed portion which is different from a case of a shaft and a bearing, thereby causing no deterioration by abrasion, so that the optical-information-reading apparatus 1A can improve durability and realize operable long-life. Additionally, any unusual sound which usually occurs in a space between a shaft and a bearing does not occur, which allows sounds of rotation to be damped.

As the middle of the plate spring 40, both ends of which are fixed on the movable member 3, is supported by the fixed axle 41 mounted on the base member 11, the optical-information-reading apparatus 1A can restrain a lateral movement or a distortion of the axis during rotation of the scanning mirror 30, which enables the rotation thereof to be performed stably.

As both arced ends of the plate spring 40 are fixed on a side of the movable member 3, the middle thereof is supported by the fixed axle 41 and the stress is exerted thereon, the plate spring 40 has high stiffness against distortion in a lateral direction, which enables the inclination of the scanning mirror 30 in any direction without the rotation operation being restrained.

Further, as the plate spring 40 is configured to have a curve between end the portions thereof fixed on the movable member 3 and at the portion thereof fixed on the fixed axle 41, a variation in size in the longitudinal direction thereof can be accommodated when the scanning mirror 30 rotates, which eliminates any restriction on the rotation angle of the scanning mirror 30.

The optical-information-reading apparatus 1A is configured so that when the movable member 3 rotates, the stress exerted on the plate spring 40 is not zero and the stress is exerted toward the same direction within a predetermined range. If it is configured so that when the movable member stays in a stationary state, the stress exerted on the plate spring is zero, a direction of the stress exerted on the plate spring is repeatedly reversed when the scanning mirror rotates with vibration within a predetermined angle. Thus, when comparing with a case of rotation in which the direction of the stress exerted on the plate spring is repeatedly reversed, such a configuration that the stress is exerted on the plate spring toward the same direction within a predetermined range enables development of fatigue in the materials to be delayed, which enables long-life thereof to be realized.

Here, the shape of the frame 31 is not limited to an arc shape, but it may be rectangular. When the outer circumference becomes a convex arc shape, the locus when the movable member 3 rotates becomes smaller, which enables the downsizing thereof to be realized. It is to be noted that a change of weight of the frame 31 allows its resonance frequency to be finely adjusted. Further, when using resin or plastics as the materials of the frame 31, the frame 31 and the plate spring 40 can be molded in one piece in a step of setting the plate spring 40 in a mold for molding the frame 31 and filling up with resin, which allows processing accuracy to be improved, assembly thereof to be simplified and production with low costs to be realized.

When a step of fixing the plate spring 40 on the fixed axle 41 is carried out by performing an insert-molding in which the plate spring 40 and the fixed axle 41 are set in the mold and a resin is introduced into a connected portion thereof, the plate spring 40 and the fixed axle 41 can be molded in one piece, which allows processing accuracy to be enhanced, assembly thereof to be simplified and the production thereof to be realized with low costs.

### Variation of Optical-Information-Reading Apparatus according to First Embodiment

FIGS. 3 through 5 are plan views of an optical-information-reading apparatus according to the first embodiment showing variation examples thereof. Although the plate spring 40 has been configured in the case shown in FIGS. 1 and 2 so that both longitudinal ends thereof are fixed on both ends of the frame 31 with the plate spring 40 being elastically deformed to have an arc shape that is convex in relation to the scanning mirror 30, it may be configured so that both longitudinal ends thereof are fixed on the frame 31, as shown in FIG. 3, with the plate spring 40 being elastically deformed to have an arc shape that is concave in relation to the scanning mirror 30.

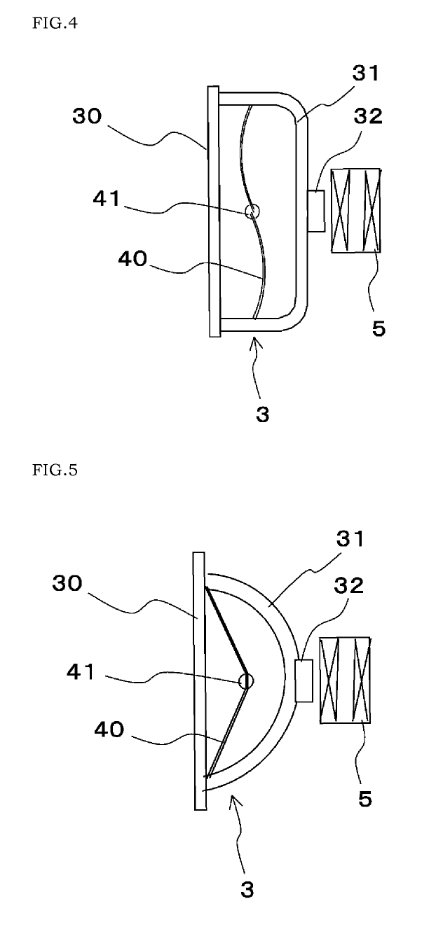

Further, as shown in FIG. 4, the plate spring 40 may be configured so that both longitudinal ends thereof are fixed on the frame 31 with the plate spring 40 on one side of the fixed axle 41 being elastically deformed to have an arc shape that is convex in relation to the scanning mirror 30 and the plate spring 40 on the other side of the fixed axle 41 being elastically deformed to have an arc shape that is concave in relation to the scanning mirror 30. Further, the portion thereof between the middle thereof fixed on the fixed axle 41 and the forward end thereof fixed on the frame 31 may have a shape that is convex and concave in relation to the same.

Additionally, as shown in FIG. 5, the plate spring 40 may be configured so as to have a triangle shape with its apex corresponding to the fixed axle 41 and it may be configured so that a portion thereof between each of the portions thereof fixed on the frame 31 and the portion thereof fixed on the fixed axle 41 is linear. It is to be noted that the plate spring 40 on both sides of the fixed axle 41 may be linear but the stiffness thereof in relation to the vertical distortion is deteriorated. Further, as it cannot accommodate variations in the longitudinal size thereof when the scanning mirror 30 rotates, the rotation angle of the scanning mirror 30 is limited.

### Configuration Example of Optical-Information-Reading Apparatus according to Second Embodiment

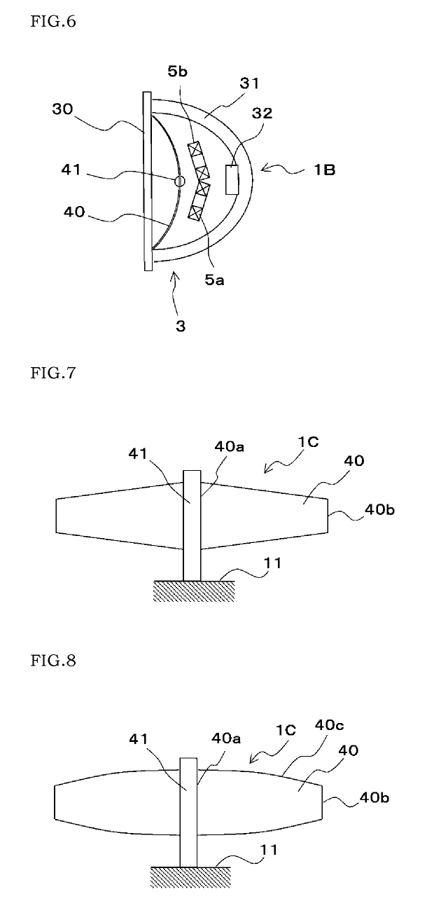

FIG. 6 is a plan view of an optical-information-reading apparatus according to a second embodiment. In the optical-information-reading apparatus 1B according to the second embodiment, the configuration of the plate spring 40 supporting the movable member 3 is the same as the configuration described in FIGS. 1 and 2.

In the optical-information-reading apparatus 1B according to the second embodiment, the fixed axle 41 supporting the plate spring 40 is made of a magnetic material and the permanent magnet 32 is attached to an inner circumference of the frame 31 facing the fixed axle 41. Air-core coils 5a and 5b are disposed between the permanent magnet 32 and the fixed axle 41 in the inner circumference of the frame 31. This causes a closed magnetic circuit by the coils 5a, 5b and the fixed axle 41 made of a magnetic material.

### Example of Operation and Effect of Optical-Information-Reading Apparatus according to Second Embodiment

In the optical-information-reading apparatus 1B according to the second embodiment, even when driving any one of the coils 5a, 5b, the scanning mirror 30 may rotate with vibration within a predetermined angle but symmetrical driving may be carried out using the two coils 5a, 5b. Further, by making the fixed axle 41 of magnetic material, magnetic flux of the permanent magnet 32 acting on the coils 5a, 5b may be enhanced. By disposing the coils 5a, 5b inside the frame 31, it is possible to downsize the apparatus.

### Configuration Example of Optical-Information-Reading Apparatus according to Third Embodiment

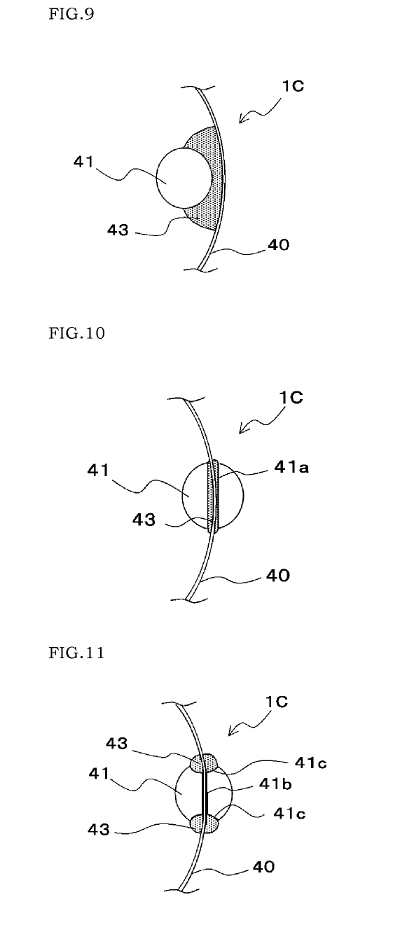

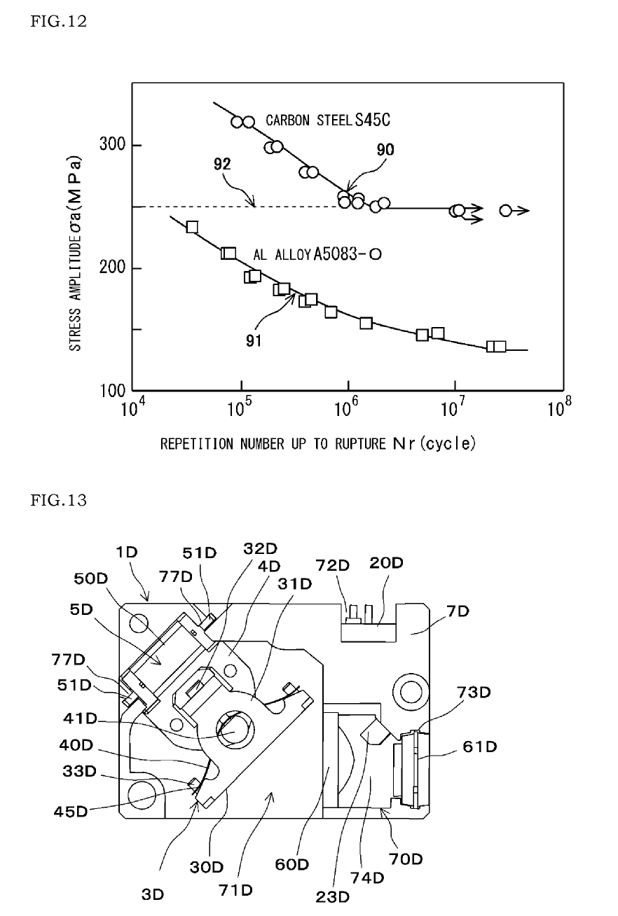

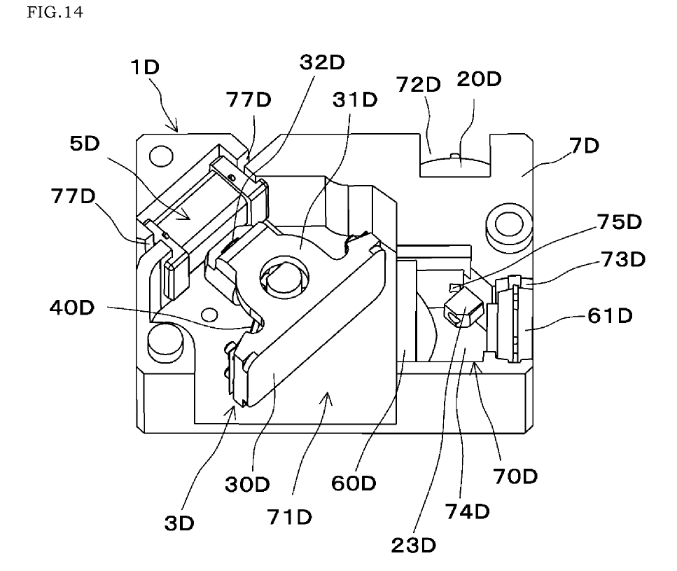

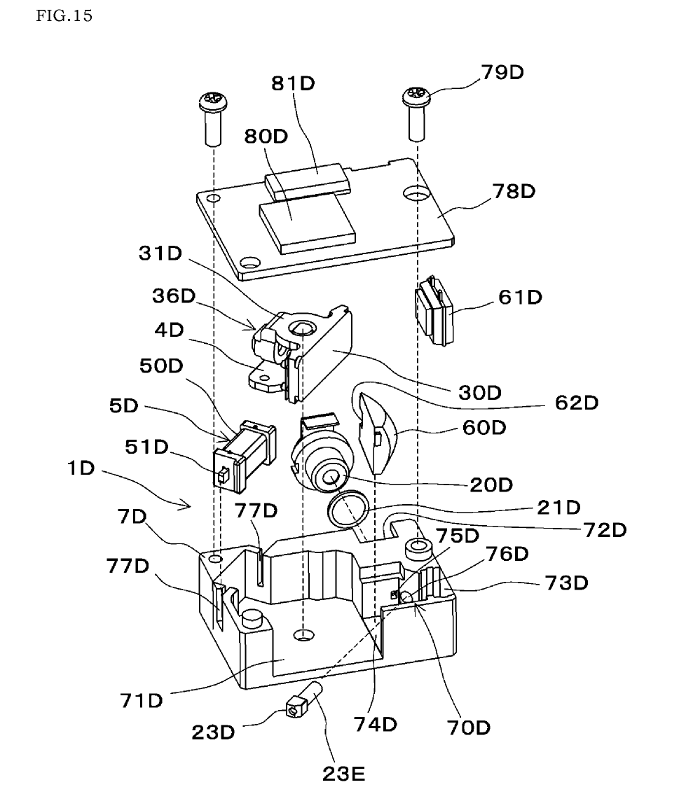

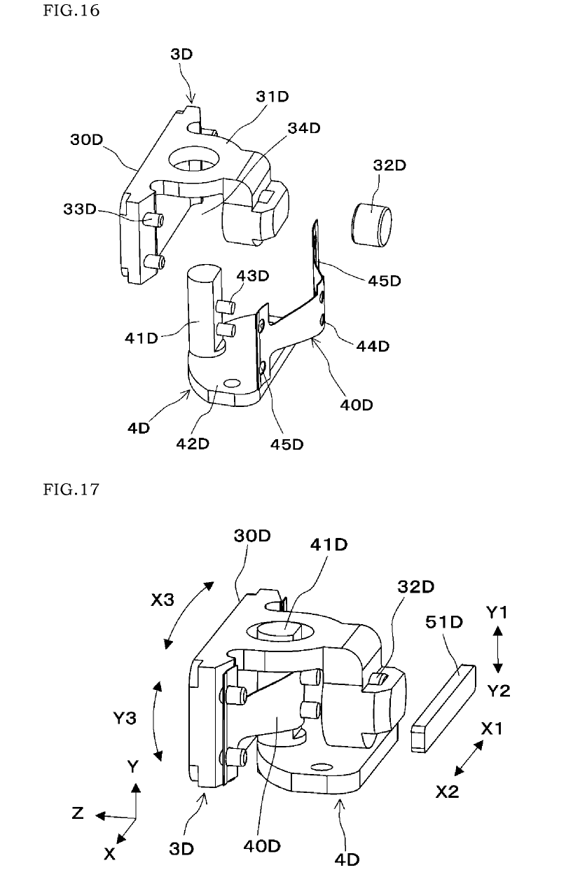

FIGS. 7 and 8 are front views of an important portion of an optical-information-reading apparatus according to a third embodiment. FIGS. 9 through 11 are plan views of the important portion of the optical-information-reading apparatus according to the third embodiment. In the optical-information-reading apparatuses according to the first and second embodiments, the plate spring 40 has been elastically deformed to be bent around the fixed axle 41 as a fulcrum and the scanning mirror 30 has rotated. This causes any internal stress to be concentrated on a fixed portion in the plate spring 40 fixed on the fixed axle 41 and if the plate spring 40 is repeatedly vibrated, fatigue occurs in the material.

The optical-information-reading apparatus 1C according to the third embodiment realizes a configuration to reduce the stress based on a shape of the plate spring 40. In other words, in a case shown in FIG. 7, the plate spring 40 is formed so that on both right and left sides of the middle 40a thereof fixed on the fixed axle 41, trapezoids have been formed. Namely, since in the plate spring 40, the stress is subject to being concentrated on a portion thereof fixed on the fixed axle 41, the middle 40a has a wider width in a lateral direction thereof but since the stress is difficult to concentrate on forward ends 40b fixed on the frame 31, they have narrower widths. Such a stress-reducing structure causes the stress to be distributed over whole of the plate spring 40 evenly, thereby enabling the stress concentration to be reduced.

In a case shown in FIG. 8, the plate spring 40 is configured so that the middle 40a fixed on the fixed axle 41 has a wider width than that of each of the forward ends 40b fixed on the frame 31 and the plate spring 40 has a curved side 40c, not straight side, between the middle 40a and any of the forward ends 40b. Based on such a stress-reducing structure, by changing the shape and a curvature of the curved side 40c, it is possible to perform with ease a design for an optimization in which minimum stress is exerted.

In cases shown in FIGS. 9 through 11, the plate spring 40 is fixed on the fixed axle 41 via elastic supporting member, which realizes a configuration to reduce the stress. Namely, in a case shown in FIG. 9, the fixed axle 41 is disposed, for example, at an inner circumference side of the plate spring 40 with an arc shape and the elastic supporting member 43 such as a rubber or rubber-like adhesive is disposed between the plate spring 40 and the fixed axle 41. Accordingly, when the scanning mirror 30 rotates as shown in FIG. 1 and the like, the stress exerted when the plate spring 40 is elastically deformed to be bent around the fixed axle 41 as a fulcrum is assimilated by the elastic supporting member 43, which enables reduction of the stress concentration in the fixed portion in the plate spring 40 fixed on the fixed axle 41.

In a case shown in FIG. 10, a groove 41a having a wider width by a predetermined amount thereof than a thickness of the plate spring 40 is formed in the fixed axle 41, and the plate spring 40, a middle of which is coated by the elastic supporting member 43 such as a rubber or rubber-like adhesive, is inserted into the groove 41a. Accordingly, the elastic supporting member 43 is disposed between the plate spring 40 and the fixed axle 41 and when the scanning mirror 30 rotates, the stress exerted when the plate spring 40 is elastically deformed to be bent around the fixed axle 41 as a fulcrum is assimilated by the elastic supporting member 43, which enables redaction of the stress concentration in the fixed portion in the plate spring 40 fixed on the fixed axle 41.

In a case shown in FIG. 11, a groove 41b having a wider width by a small amount than a thickness of the plate spring 40 is formed in the fixed axle 41, and the middle of the plate spring 40 is inserted into the groove 41b and fixed. Filling spaces 41c each having wider width by a predetermined amount than a thickness of the plate spring 40 are formed in portions of the groove 41b near the outer circumference of the fixed axle 41 and the elastic supporting member 43 such as rubber or rubber-like adhesive is filled in the filling space 41c. Accordingly, the elastic supporting member 43 is disposed between the plate spring 40 and the fixed axle 41 and in the portions thereof near the outer circumference of the fixed axle 41, on which the stress is subject to being concentrated, and when the scanning mirror 30 rotates, the stress exerted when the plate spring 40 is elastically deformed to be bent around the fixed axle 41 as a fulcrum is assimilated by the elastic supporting member 43, which enables reduction of the stress concentration in the fixed portions in the plate spring 40 fixed on the fixed axle 41.

<Relationship between Materials for Plate Spring and Fatigue Limit>

The following will describe a relationship between the materials for the plate spring 40 and the fatigue limit. The materials for the plate spring 40 may be any materials having elasticity such as metal, fiber and high polymer chemicals.

FIG. 12 is a graph showing characteristics of maximum stress amplitude versus repetition cycling, which indicates fatigue characteristics of carbon steel S45C of typical steel materials and aluminum alloy A-5083-O of nonferrous materials. The fatigue characteristics of materials such as aluminum alloy, brass and plastics are similar to the curve 91, in which the more the repetition number of the vibration is increased, maximum rupture stress is decreased, so that rupture by fatigue is inevitable with a very large number of repetitions because there is no fatigue limit.

On the plate spring 40 applied to the optical-information-reading apparatus according to this embodiment, when the scanning mirror 30 rotates with vibration within a predetermined angle, the stress is repeatedly exerted as a fulcrum on the fixed axle 41. Accordingly, if the plate spring 40 is made of materials such as aluminum alloy, brass and plastics, the rupture by fatigue may occur in a very large number of repetitions.

On the other hand, the fatigue characteristics of materials such as steel materials and titanium are similar to the curve 90, in which the level straight line is shown near the repetition number of 10⁷ (ten million) times or more. This means that, even if the repetition number is enough increased, the stress generating the fatigue remains unchanged. Such a stress 92 indicated by the level straight line is referred to as the fatigue limit of upper limited value in the stress, below which the materials can bear unlimited repetitions. When the stress is repeatedly exerted thereon below the fatigue limit, they have characteristics such that no fatigue occurs therein even if unlimited repetitions are performed.

Accordingly, in the optical-information-reading apparatus 1A according to the first embodiment, when the plate spring 40 is made of steel materials and the stress reducing structure described on FIG. 9 is applied thereto, it was found out that there was no rupture in the plate spring 40 even if the vibrations in excess of the repetition number of 10⁸ times are repeatedly applied.

In the optical-information-reading apparatus according to the present invention, by using these characteristics for the fatigue limit, materials having such a fatigue limit are used in the plate spring 40. By using both of the characteristics for the fatigue limit in the plate spring 40 and any of the stress reducing structures described on FIGS. 7 through 11 and designing the maximum stress so as to be lower than the stress of the fatigue limit, long-life vibrations may be permanently satisfied.

### Specific Example of Optical-Information-Reading Apparatus

FIG. 13 is a plan view of the optical-information-reading apparatus according to each embodiment; FIG. 14 is a perspective view of the optical-information-reading apparatus; FIG. 15 is an exploded perspective view of the optical-information-reading apparatus; and FIG. 16 is an exploded perspective view of a scanning mirror assembly.

The optical-information-reading apparatus 1D according to this embodiment is provided with a light source 20D composed of semiconductor laser (LD) or the like, a focus lens 21D focusing the light emitted from the light source 20D with a predetermined angle of radiation, and a mirror 23D reflecting beam light which is emitted from the light source 20D and is focused by the focus lens 21D or is parallel beam, and changing an optical path thereof.

The optical-information-reading apparatus 1D is also provided with a movable member 3D having a scanning mirror 30D which scans the light emitted from the light source 20D, a supporting member 4D supporting the movable member 3D by a plate spring 40D, and a coil assembly 5D allowing the movable member 3D to be vibrated within a predetermined angle by the rotation of the movable member 3D around an axis formed by the plate spring 40D as a fulcrum.

The optical-information-reading apparatus 1D is further provided with a light-receiving lens 60D imaging the reflected light of the light scanned by the scanning mirror 30D, and a photodiode (PD) 61D performing photoelectric conversion on the light imaged by the light-receiving lens 60D and outputting an electrical signal.

The optical-information-reading apparatus 1D is provided with an optical mechanism installing portion 70D and a scanning mechanism installing portion 71D on the case body 7D having, for example, a rectangular shape. In the optical mechanism installing portion 70D, an opening having a predetermined shape is formed on a side portion of the case body 7D and an LD installing portion 72D is formed therein. The focus lens 21D and the light source 20D are installed in the LD installing portion 72D.

In the optical mechanism installing portion 70D, an opening having a predetermined shape is also formed on a part of an upper surface of the case body 7D and a PD installing portion 73D is formed therein. The photodiode 61D is installed in the PD installing portion 73D. In the optical mechanism installing portion 70D, an opening having a predetermined shape and communicating with the PD installing portion 73D is further formed on a part of the upper surface of the case body 7D and an optical parts installing portion 74D is formed therein. The mirror 23D and the light-receiving lens 60D are installed in the optical parts installing portion 74D.

In the optical mechanism installing portion 70D, an optical path forming aperture 75D, through which the light emitted from the light source 20D passes, is formed between the LD installing portion 72D and the optical parts installing portion 74D. In such a configuration, the light emitted from the light source 20D may be incident on the mirror 23D installed in the optical parts installing portion 74D.

In the optical-information-reading apparatus 1D, the LD installing portion 72D and the PD installing portion 73D are configured so that when the light source 20D and the photodiode 61D are installed in the case body 7D, light emitted from the light source 20D and light that is incident on the photodiode 61D intersect with each other, for example, at right angles.

In the optical-information-reading apparatus 1D, the mirror 23D is disposed within the optical path of the light emitted from the light source 20D and outside of the optical path of the light reflected by the scanning mirror 30D. Thus, light emitted from the light source 20D is reflected by the mirror 23D and is incident on the scanning mirror 30D. As well, light reflected by the scanning mirror 30D is not incident on the mirror 23D but is incident on the photodiode 61D.

The mirror 23D is configured as either a mirror with a flat reflection surface, or a cylindrical mirror, a reflection surface of which has a cylindrical shape. Further, the mirror 23D is provided with an axle 23E which is inserted into an install hole 76D formed in the optical parts installing portion 74D. The mirror 23D is configured so that the direction of the reflection surface thereof is adjustable by inserting the axle 23E into the install hole 76D so as to be installed in the optical parts installing portion 74D and rotating it around the axle 23E.

The light-receiving lens 60D is configured to have an optical path forming opening 62D formed so as to be in the optical path of the light emitted from the light source 20D and reflected by the mirror 23D. In such a configuration, the light emitted from the light source 20D passes through the optical path forming opening 62D and is incident on the scanning mirror 30D, but it is not passed through the light-receiving lens 60D. The light reflected by the scanning mirror 30D is then passed through the light-receiving lens 60D and is incident on the photodiode 61D.

In the scanning mechanism installing portion 71D, an opening having a predetermined shape and communicating to the optical parts installing portion 74D is provided or formed on a part of the upper surface of the case body 7D and the supporting member 4D, which supports the movable member 3D by the plate spring 40D, is installed therein.

In the scanning mechanism installing portion 71D, an opening having a predetermined shape is provided on a part of the upper surface of the case body 7D to form a coil installing portion 77D and the coil assembly 5D is installed in the coil installing portion 77D.

The movable member 3D is provided with a frame 31D on which the scanning mirror 30D is provided and with a permanent magnet 32D which is mounted on the frame 31D. In the movable member 3D, the scanning mirror 30D is provided on a front surface of the frame 31D and a spring installing portion 33D is formed on a rear surface of the frame 31D. The spring installing portion 33D is configured so that in this example, two projections are provided at either end of the frame 31D along the longitudinal direction of the scanning mirror 30D. In the movable member 3D, a mirror installing space 34D is formed on a surface of the frame 31D and the permanent magnet 32D is installed on a portion of the frame 31D behind the mirror installing space 34D.

The supporting member 4D is provided with a fixed axle 41D supporting the plate spring 40D, and a supporting portion 42D for mounting the fixed axle 41D on the scanning mechanism installing portion 71D. In the supporting member 4D, a configuration is provided such that the fixed axle 41D on the supporting portion 42D and a spring installing portion 43D is formed on the fixed axle 41D. The spring installing portion 43D is configured, in this example, to have two projections.

The plate spring 40D is a plate elastic member made of a steel material such as stainless steel. A middle thereof, has a wider shape in which an axle attaching portion 44D is formed and both ends thereof have wider shapes in which a mirror attaching portion 45D is formed. The axle attaching portion 44D is configured to have two openings into which the two projections on portion 43D are fitted. Similarly, the mirror attaching portion 45D is configured to have openings into which the projections on portions 33D are fitted.

The plate spring 40D is configured so that, by fitting the spring installing portion 43D composed of the projections of the fixed axle 41D into the axle attaching portion 44D composed of the penetrations and crimping the spring installing portion 43D, the middle thereof is supported by the fixed axle 41D of the supporting member 4D.

The plate spring 40D is bent so that the longitudinal ends thereof are fixed on the movable member 3D with an initial stress being exerted by fitting the spring installing portion 33D composed of the projections of the fixed axle 31D into the mirror attaching portion 45D composed of the penetrations and crimping the spring installing portion 33D, while both longitudinal ends thereof are bent toward the same direction and they are elastically deformed so as to be convex in relation to the scanning mirror 30D.

Thus, the plate spring 40D is disposed in the mirror installing space 34D between a rear surface of the scanning mirror 30D and the permanent magnet 32D, and a scanning mirror assembly 36D is composed in which the movable member 3D and the supporting member 4D are formed as one piece (See FIG. 17).

The fixed axle 41D is placed on a center line of the scanning mirror 30D in its longitudinal direction, and the movable member 3D can keep the scanning mirror 30D stationary toward a predetermined direction in a state in which a stress is exerted on the plate spring 40D. Further, in the movable member 3D, the plate spring 40D is elastically deformed around the fixed axle 41D as a fulcrum so that the scanning mirror 30D can rotate. An axis which is a center of rotation of the scanning mirror 30D is positioned on the center line of the scanning mirror 30D. Here, the rotation angle of the movable member 3D, the shape of the plate spring 40D, and the like, are set so that when the movable member 3D rotates, the stress exerted on the plate spring 40D is not zero.

The coil assembly 5 is provided with a coil 50D and a yoke 51D inserted into the coil. The yoke 51D is made, for example, of soft steel and is inserted into the coil 50D so that its installed position is adjustable along the longitudinal direction thereof and both longitudinal ends thereof project from both ends of the coil 50D.

The coil installing portion 77D is configured so as to have grooves into which are fitted the ends of yoke 51D projecting from the ends of coil 50D. The coil assembly 5D is mounted on the coil installing portion 77D facing the permanent magnet 32D of the movable member 3D so that the fixed axle 41D is between the ends of coil 50D and yoke 51D in their longitudinal direction. Thus, the coil assembly 5D and the permanent magnet 32D constitute the driving portion.

In the coil installing portion 77D, the shapes of the grooves into which the yoke 51D is fitted, the shape of the space in the coil installing portion 77D and the like are configured so that the installed position of the yoke 51D is adjustable relative to the longitudinal direction of the yoke 51D and is adjustable along the fixed axle 41D of the scanning mirror assembly 36D.

In the optical-information-reading apparatus 1D, a substrate 78D for covering the openings of the optical mechanism installing portion 70D and the scanning mechanism installing portion 71D is fixed on the upper surface of the case body 7D by screws 79D. On the substrate 78D, for example, there are mounted an LSI 80D that performs driving of the movable member 3D and any signal processing, an interface 81D such as a connector connecting external equipment, and the like.

### Alignment Operation Example of Optical Axis of Optical-Information-Reading Apparatus according to this Embodiment

FIG. 17 is an explanation drawing of the optical-information-reading apparatus according to this embodiment showing an example of an alignment operation of the optical axis. In the optical-information-reading apparatus 1D, as described above, the installed position of the yoke 51D is adjustable along its longitudinal direction and is adjustable relative to the fixed axle 41D of the scanning mirror assembly 36D. The adjustment of the installed position of the yoke 51D enables the optical axis to be adjusted on the basis of attraction power between the yoke 51D and the permanent magnet 32D.

As shown in FIG. 17, it is supposed that the longitudinal direction of the scanning mirror 30D along the longitudinal direction of the yoke 51D is set as an X axis; the lateral direction of the scanning mirror 30D intersected to the longitudinal direction of the yoke 51D is set as a Y axis; and a direction intersected to the surface of the scanning mirror 30D, which is intersected to the longitudinal direction of the yoke 51D, is set as a Z axis.

By moving the installed position of the yoke 51D to a direction indicated by an arrow X1 or X2 along the X axis, it is possible to adjust a direction, which is indicated by an arrow X3, of the rotation of the scanning mirror 30D along a direction which is parallel to the scanning direction, thereby enabling a light-emitting direction to be adjusted in the direction which is parallel to the scanning direction.

By moving the installed position of the yoke 51D to a direction indicated by an arrow Y1 or Y2 along the Y axis, it is possible to adjust an inclination of the scanning mirror 30D, which is indicated by an arrow Y3, along a direction which is perpendicular to the scanning direction, thereby enabling a light-emitting direction to be adjusted in the direction which is perpendicular to the scanning direction.

Thus, by providing a coil installing portion 77D which can adjust the installed position of the yoke 51D, it is possible to adjust the posture of the scanning mirror 30D in the direction which is parallel to the scanning direction and the direction which is perpendicular to the scanning direction, based on the installed position of the yoke 51D. Thus, any other components for adjusting the optical axis are unnecessary, thereby allowing manufacturing costs thereof to be reduced and the apparatus to be downsized.

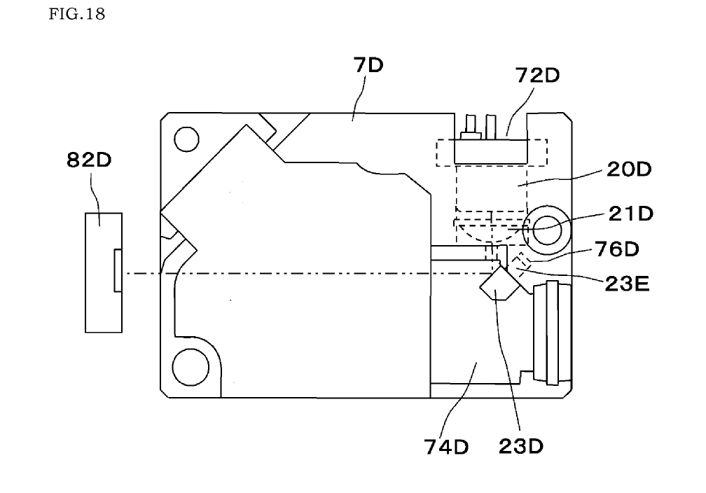

FIG. 18 is an explanation drawing of the optical-information-reading apparatus according to this embodiment showing a second alignment operation example of the optical axis. In the optical-information-reading apparatus 1D, as described above, the axle 23E which is provided in the mirror 23D is inserted into the install hole 76D formed in the optical parts installing portion 74D and by rotating the mirror 23D about the axis 23E, the direction of the reflection surface thereof is adjustable.

Accordingly, as shown in FIG. 18, the case body 7D has the light source 20D and the focus lens 21D installed in the LD installing portion 72D in the case body 7D. The mirror 23D is installed in the optical parts installing portion 74D and is positioned on measuring equipment, not shown, and the light emitted from the light source 20D and reflected by the mirror 23D is incident on a light-receiving portion 82D of the measuring equipment.

Further, the mirror 23D rotates around the axis 23E, so that a spot of the light emitted from the light source 20D and reflected by the mirror 23D enters within a predetermined range in the light-receiving portion 82D and it is fixed at a desired position by rotating mirror 23D. This enables the optical axis of the light which is incident on the scanning mirror 30D to be easily adjusted.

### Example of Operation and Effect of Optical-Information-Reading Apparatus according to This Embodiment

In the optical-information-reading apparatus 1D, when the coil 50D is driven with an electric current, impellent force is induced in a direction along the longitudinal direction of the plate spring 40D based on magnetic flux of the opposed permanent magnet 32D. The induced force is transferred to the plate spring 40D through the frame 31D. Accordingly, the plate spring 40D is elastically deformed around the fixed axle 41D so that the scanning mirror 30D rotates.

When the direction of the electric current flow in the coil 50D is changed, the direction of the induced force is changed, and the scanning mirror 30D rotates with vibration within a predetermined angle based on the induced force and restoring force of the plate spring 40D.

The optical-information-reading apparatus 1D deflects the light which is emitted from the light source 20D, is reflected by the mirror 23D and is incident on the scanning mirror 30D by rotating the scanning mirror 30 and scans it across a code symbol 10 composed of patterns having different optical reflectivity such as a one-dimensional code and a two-dimensional code. Further, in the optical-information-reading apparatus 1D, the reflected light of the light scanned across the code symbol is incident on the scanning mirror 30D, reflected by the scanning mirror 30D, and passes through the light-receiving lens 60D to be imaged on the photodiode 61D. Via photoelectric conversion the photoelectric produces an output signal from which the information is read.

The optical-information-reading apparatus 1D has an effect which is similar to that of each of the above-mentioned embodiments, and as the axis which is a center of the rotation of the scanning mirror 30D is an imaginary fulcrum when the plate spring 40D is deformed, there is no rubbed portion, as with a shaft and a bearing, thereby causing no deterioration by abrasion, so that the optical-information-reading apparatus 1D can improve durability and realize long-life. Further, the unusual sounds which occur, as when there is a space between a shaft and bearing do not occur, which allows sound of the rotation thereof to be damped.

As the middle of the plate spring 40D, both ends of which are fixed on the movable member 3D, is supported by the fixed axle 41D, which is fixed on the scanning mechanism installing portion 71D, the optical-information-reading apparatus 1D can restrain a lateral movement or distortion of the axis of a rotation of the scanning mirror 30, thereby enabling the rotation thereof to be performed stably.

Both ends of the plate spring 40D are bent toward the same direction and are fixed on the movable member 3. The middle of plate spring to is supported by the fixed axle 41D, and it is supported while stress is exerted thereon. Thus, the plate spring 40D has high stiffness against a vertical distortion along the lateral direction thereof, which enables the inclination of the scanning mirror 30 into any direction without the rotation operation being restrained.

The optical-information-reading apparatus 1D is also configured so that when the movable member 3D rotates, the stress exerted on the plate spring 40D is not zero and the stress is exerted toward the same direction within a predetermined range. Accordingly, compared with the case of rotation in which the direction of the stress exerted on the plate spring is repeatedly reversed, progress of any fatigue in the materials is delayed, which enables long-life to be realized.

The optical-information-reading apparatus according to the present invention is preferable to a barcode reader or two-dimension code reader, because it allows sounds of the apparatus to be damped and long-life thereof to be realized.

### DESCRIPTION OF CODES

1A, 1B, 1C, 1D: Optical-Information-Reading apparatus;

2: Light-Irradiating Portion;

3, 3D: Movable Member;

4: Supporting Member;

5: Coil;

5D: Coil Assembly;

6: Light-Receiving Member;

7D: Case Body;

20, 20D: Light Source;

30, 30D: Scanning Mirror;

31, 31D: Frame

32, 32D: Permanent Magnet;

40, 40D: Plate Spring;

41, 41D: Fixed Axle;

50D: Coil;

51D: Yoke;

60D: Photodiode;

70D: Optical Mechanism Installing Portion;

71D: Scanning Mechanism Installing Portion;

72D: LD Installing Portion;

73D: PD Installing Portion;

74D: Optical Parts Installing Portion; and

77D: Coil Installing Portion.

1. An optical-information-reading apparatus comprising:
a light-irradiating portion which emits light;
a movable member which includes a mirror reflecting the light emitted from the light-irradiating portion;
a supporting portion which supports the movable member rotatably;
a driving portion which drives the movable member rotatably; and
a light-receiving portion which receives reflected light of the light that is emitted from the light-irradiating portion and is scanned across an object to be read by the rotation of the movable member,
a plate elastic member in the supporting portion, having opposite ends which are fixed on the moving member; and
a fixed axle which supports a portion of the elastic member intermediate its ends.

2. The apparatus of claim 1 wherein the supported portion of the plate elastic member is substantially mid-way between the ends.

3. The apparatus according to claim 1 or 2 wherein the elastic member is bent to a state in which a stress is exerted thereon and both ends thereof are fixed on the movable member in such state.

4. The apparatus according to claim 3 wherein the elastic member has a length extending between the ends and a width generally crosswise to its length, there being a stress reduction structure in the vicinity of the portion fixed on the fixed axle which is of increased width.

5. The apparatus according to claim 4 wherein the elastic member has a curved side between the middle portion thereof fixed on the fixed axle and any of the forward ends fixed on the movable member.

6. The apparatus according claim 5 wherein the elastic member has a stress reduction structure in which the portion thereof fixed on the fixed axle is supported on the fixed axle through an elastically supporting member.

7. The apparatus according to claim 6 wherein the elastic member is composed of a material having a fatigue limit in which maximum stress is unchanged regardless of the repetition frequency of vibration.

8. The apparatus according to claim 7 wherein the movable member is fixed behind the mirror and has a frame on which the ends of the elastic member are fixed,
the driving portion having a permanent magnet which is fixed on an internal surface of the frame, the permanent magnet facing the fixed axle, and a coil which is positioned between the permanent magnet and the fixed axle, and
the fixed axle being composed of a magnetic material to form a closed magnetic circuit.

9. The apparatus according to claim 1 or 2 wherein the elastic member has a length extending between the ends and a width generally crosswise to its length, there being a stress reduction structure in the vicinity of the portion fixed on the fixed axle which is of increased width.

10. The apparatus according to claim 3 wherein the elastic member has a curved side between the middle portion thereof fixed on the fixed axle and any of the forward ends fixed on the movable member.

11. The apparatus according to claim 1 or 2 wherein the elastic member has a curved side between the middle portion thereof fixed on the fixed axle and any of the forward ends fixed on the movable member.

12. The apparatus according claim 4 wherein the elastic member has a stress reduction structure in which the portion thereof fixed on the fixed axle is supported on the fixed axle through an elastically supporting member.

13. The apparatus according claim 3 wherein the elastic member has a stress reduction structure in which the portion thereof fixed on the fixed axle is supported on the fixed axle through an elastically supporting member.

14. The apparatus according claim 1 or 2 wherein the elastic member has a stress reduction structure in which the portion thereof fixed on the fixed axle is supported on the fixed axle through an elastically supporting member.

15. The apparatus according to claim 6 wherein the elastic member is composed of a material having a fatigue limit in which maximum stress is unchanged regardless of the repetition frequency of vibration.

16. The apparatus according to claim 5 wherein the elastic member is composed of a material having a fatigue limit in which maximum stress is unchanged regardless of the repetition frequency of vibration.

17. The apparatus according to claim 4 wherein the elastic member is composed of a material having a fatigue limit in which maximum stress is unchanged regardless of the repetition frequency of vibration.

18. The apparatus according to claim 3 wherein the elastic member is composed of a material having a fatigue limit in which maximum stress is unchanged regardless of the repetition frequency of vibration.

19. The apparatus according to claim 1 or 2 wherein the elastic member is composed of a material having a fatigue limit in which maximum stress is unchanged regardless of the repetition frequency of vibration.

20. The apparatus according to claim 6 wherein the movable member is fixed behind the mirror and has a frame on which the ends of the elastic member are fixed,
the driving portion having a permanent magnet which is fixed on an internal surface of the frame, the permanent magnet facing the fixed axle, and a coil which is positioned between the permanent magnet and the fixed axle, and
the fixed axle being composed of a magnetic material to form a closed magnetic circuit.

21. The apparatus according to claim 5 wherein the movable member is fixed behind the mirror and has a frame on which the ends of the elastic member are fixed,
the driving portion having a permanent magnet which is fixed on an internal surface of the frame, the permanent magnet facing the fixed axle, and a coil which is positioned between the permanent magnet and the fixed axle, and
the fixed axle being composed of a magnetic material to form a closed magnetic circuit.

22. The apparatus according to claim 4 wherein the movable member is fixed behind the mirror and has a frame on which the ends of the elastic member are fixed,
the driving portion having a permanent magnet which is fixed on an internal surface of the frame, the permanent magnet facing the fixed axle, and a coil which is positioned between the permanent magnet and the fixed axle, and
the fixed axle being composed of a magnetic material to form a closed magnetic circuit.

23. The apparatus according to claim 3 wherein the movable member is fixed behind the mirror and has a frame on which the ends of the elastic member are fixed,
the driving portion having a permanent magnet which is fixed on an internal surface of the frame, the permanent magnet facing the fixed axle, and a coil which is positioned between the permanent magnet and the fixed axle, and
the fixed axle being composed of a magnetic material to form a closed magnetic circuit.

24. The apparatus according to claim 1 or 2 wherein the movable member is fixed behind the mirror and has a frame on which the ends of the elastic member are fixed,
the driving portion having a permanent magnet which is fixed on an internal surface of the frame, the permanent magnet facing the fixed axle, and a coil which is positioned between the permanent magnet and the fixed axle, and
the fixed axle being composed of a magnetic material to form a closed magnetic circuit.
